(19) United States
(12) Patent Application Publication
(10) Pub. No.: US 2025/0118779 A1
(43) Pub. Date: Apr. 10, 2025

(54) BIPOLAR PARAMETHOXYPHENYL CONTAINING REDOX MOLECULES

(71) Applicant: ExxonMobil Technology and Engineering Company, Spring, TX (US)

(72) Inventors: Ross Mabon, Whitehall, PA (US); Jordan N. Metz, Doylestown, PA (US); Satish Bodige, Wayne, NJ (US); Latoya S. Chambers, Irvington, NJ (US); Divyaraj Desai, Stewartsville, NJ (US)

(73) Assignee: ExxonMobil Technology and Engineering Company, Spring, TX (US)

(21) Appl. No.: 18/897,833

(22) Filed: Sep. 26, 2024

Related U.S. Application Data
(60) Provisional application No. 63/588,191, filed on Oct. 5, 2023.

(51) Int. Cl. H01M 8/04186; H01M 8/18

(52) U.S. Cl. CPC H01M 8/04186; H01M 8/188

(57) ABSTRACT

Disclosed herein are a variety of systems, compositions, and methods for reversibly storing electrical energy in a redox flow battery with a unit cell potential equal to or greater than 3.5 volts. The systems include a positive section, a negative section, and an electroactive bipolar redox molecule comprising an anolyte moiety and a catholyte moiety separated by a non-conjugating insulating linker. The catholyte moiety comprises para-dimethoxybenzene and the non-conjugating insulating linker comprises at least two -CX₂ linkers, wherein X comprises at least one atom selected from the group consisting of hydrogen and heteroatoms. The positive section comprises a first metal electrode in contact with the electroactive bipolar redox molecule and a supporting electrolyte dissolved in a solvent. The negative section comprises a second metal electrode in contact with the electroactive bipolar redox molecule and additional electrolyte dissolved in additional solvent.

### CROSS REFERENCE TO RELATED APPLICATIONS

This application claims the priority of U.S. Provisional Patent Application No. 63/588,191, filed Oct. 5, 2023, which is incorporated by reference in its entirety.

### FIELD

This disclosure relates to electrochemical energy storage comprising high-voltage bipolar redox organic molecules and redox flow battery systems utilizing these molecules for energy storage.

### BACKGROUND

Renewable energy sources, such as wind and solar power, provide intermittent energy that does not coincide with peak load times all the time. Thus, there is a need for large scale energy storage integrated into the electric grid. Redox flow batteries are capable of storing large amounts of energy by converting electrical energy into electrochemical potential energy. The stored electrochemical energy can be converted back into electrical energy upon discharge with reversal of the opposite redox reactions.

Redox flow batteries, also called semi-fuel cells, are powered by electroactive species dissolved in liquid electrolyte solutions: a catholyte and an anolyte. The electrolyte can also be in slurry or emulsion form. The liquid electrolyte solutions may be stored in large tanks and flowed through parallel plates between current collectors and an ion selective membrane. The energy storage capacity may be determined by the number of moles of redox-active species, while the power output is determined by the active area of the electrochemical stack. Therefore, redox flow batteries have the unique benefit of independent power and energy scaling. This attribute is particularly advantageous for longer duration energy storage, wherein the cost of storage is primarily driven by the fluid cost.

Typical redox flow battery system includes one or more redox-active species, an optional supporting electrolyte and an optional solvent and a stack comprising one or more electrochemical cells. The electrochemical stack comprises current collectors, optional high-surface area electrodes, optional ion-selective membranes or porous separators and an optional fluid transport device, such as a peristaltic pump.

Most redox flow batteries utilize dissimilar redox species at the anode electrolyte (anolyte) and at the cathode electrolyte (catholyte). This results in a concentration gradient of each redox-active species on either side of the ion-transport membrane or porous separator, resulting in a steady flux in the diffusion of the redox-active species, i.e., anolyte into the catholyte half-cell and vice versa. This diffusive redox-active species flux is referred to as redox crossover and can result in considerable loss of battery capacity during typical operation.

### SUMMARY

Disclosed herein is a system for energy storage including a positive section, a negative section, and an electroactive bipolar redox molecule comprising an anolyte moiety and a catholyte moiety separated by a non-conjugating insulating linker. The catholyte moiety comprises para-dimethoxybenzene and the non-conjugating insulating linker comprises at least two -CX₂ linkers, wherein each X comprises at least one atom individually selected from the group consisting of hydrogen and a heteroatom. The positive section comprises a first metal electrode in contact with the electroactive bipolar redox molecule and a supporting electrolyte dissolved in a solvent. The negative section comprises a second metal electrode in contact with the electroactive bipolar redox molecule and additional electrolyte dissolved in additional solvent.

Further disclosed herein is a composition including a single electroactive bipolar redox molecule comprising an anolyte moiety and a catholyte moiety separated by a non-conjugating insulating linker, wherein the catholyte moiety comprises para-dimethoxybenzene and the non-conjugating insulating linker comprises at least two -CX₂ linkers, wherein each X comprises at least one atom individually selected from the group consisting of hydrogen and a heteroatom; a supporting electrolyte dissolved in a solvent; and additional electrolyte dissolved in additional solvent.

Disclosed herein is also a method for reversibly storing electrical energy in a redox flow battery with a unit cell potential equal to or greater than 3.0 volts. The method includes flowing a catholyte into contact with a first metal electrode in a positive section of the redox flow battery, wherein the catholyte comprises a single electroactive bipolar redox molecule comprising an anolyte moiety and a catholyte moiety separated by a non-conjugating insulating linker, wherein the catholyte moiety comprises para-dimethoxybenzene and the non-conjugating insulating linker comprises at least two -CX₂ linkers, wherein each X comprises at least one atom individually selected from the group consisting of hydrogen and a heteroatom; flowing an anolyte into contact with a second metal electrode in a negative section of the redox flow battery, wherein the negative section is separated from the positive section with an ion-transporting membrane, wherein the anolyte comprises an additional portion of the organic molecule dissolved in additional solvent; and supplying electrical energy to the first metal electrode and the second metal electrode while an external load is not in electrical communication with the first metal electrode and the second metal electrode to charge the redox flow battery while flowing the catholyte and flowing the anolyte.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings.

FIG. 1 is a cyclic voltammogram of 5 mM p-dimethoxybenzene+0.1 M N-tetrabutylammonium hexafluorophosphate (TBAPF₆) in acetonitrile (100 mV/s) between +0.5 V to +1.25 V.

FIG. 2 is a cyclic voltammogram of 5 mM biphenyl+0.1 M N-tetrabutylammonium hexafluorophosphate (TBAPF₆) in acetonitrile (100 mV/s) between −3.2 V to +0 V.

FIG. 3A is a cyclic voltammogram of 5 mM trans-stilbene+0.1M TBAPF₆ in acetonitrile at 100 mV/s between −3.2 to +1.5 V.

FIG. 3B is a cyclic voltammogram of 5 mM trans-stilbene+0.1M TBAPF₆ in acetonitrile at 100 mV/s between −4 V to −1 V.

FIG. 4 is a cyclic voltammogram of 5 mM 1-methylnaphthalene+0.1M TBAPF₆ in acetonitrile at 100 mV/s between −3.1 V to +0 V (1).

FIG. 5 is a cyclic voltammogram of 5 mM benzophenone+0.1M TBAPF₆ in acetonitrile at 100 mV/s between −2.5 to +0 V.

FIG. 6 is a schematic of a membrane characterization setup to assess redox permeability and membrane ionic conductivity of one or more embodiments.

FIG. 7 is a cyclic voltammogram of 5 mM bipolar compound (1)+0.1M TBAPF₆ in acetonitrile at 100 mV/s between −3.1 V to +1.1 V.

FIG. 8 is a cyclic voltammogram of 5 mM bipolar compound (2)+0.1M TBAPF₆ in acetonitrile at 100 mV/s between −2.85 V to +1.15 V.

FIG. 9 is a cyclic voltammogram of 5 mM bipolar compound (3)+0.1M TBAPF₆ in acetonitrile at 100 mV/s between −3.2 V to +1.15 V.

FIG. 10 is a cyclic voltammogram of 5 mM bipolar compound (4)+0.1M TBAPF₆ in acetonitrile at 250 mV/s between −1.55 V to +1.15 V.

FIG. 11 is a cyclic voltammogram of 5 mM bipolar compound (5)+0.1M TBAPF₆ in acetonitrile at 100 mV/s between −3.0 V to +1.25 V.

FIG. 12 is a cyclic voltammogram of 5 mM bipolar compound (6)+0.1M TBAPF₆ in acetonitrile at 250 mV/s between −3.0 V to +1.5 V.

FIG. 13 is a cyclic voltammogram of 5 mM bipolar compound (7)+0.1M TBAPF₆ in acetonitrile at 100 mV/s between −3.0 V to +0 V.

### DETAILED DESCRIPTION

This application relates to redox flow batteries and, more particularly, embodiments relate to redox electrochemical systems comprising an electroactive bipolar redox molecule. The redox flow batteries may be considered symmetric as the electroactive bipolar redox molecule can be used as the anolyte and the catholyte.

Example embodiments of the electroactive bipolar redox molecule combine anolyte and catholyte moieties separated by a non-conjugating insulating linker. Outstanding electrochemical cell potentials are achieved by combining para-dimethoxybenzene as catholyte moiety with 1-methylnaphthalene as anolyte moiety, para-dimethoxybenzene as catholyte moiety with biphenyl as anolyte moiety, and combining para-dimethoxybenzene as catholyte moiety with stilbene as anolyte moiety using at least two -CX₂ linkers between the redox active moieties, wherein each X comprises at least one atom individually selected from the group consisting of hydrogen and a heteroatom. High electrochemical cell potential is defined in this disclosure as a cell potential equal to, or above, 3.0 V. However, if these redox active moieties were linked with one -CH₂ linker, the resulting molecules are redox inactive. Therefore, the -CX₂ linker between the redox active moieties includes at least two-CX₂ groups in accordance with example embodiments. Further, the position of the oxygen atom in the linker can have an impact on the electrochemical cell potential.

Symmetric redox-active species utilizing multiple redox states of a transition metal have been reported in the literature. The vanadium redox flow battery is the most well-known of these systems and utilizes a [VO]⁺²|[VO₂]⁺ redox couple as the anolyte, and a V⁺²|V⁺³ couple as the catholyte. While this chemistry is capable of achieving very long cycle life (e.g., >10,000 cycles), the thermodynamic cell potential and resulting energy density is quite low.

TABLE 1
Reactions in a Symmetric Vanadium Redox Flow Battery.

| | Redox potential |
|---|---|
| Electrochemical reaction | (V vs SHE) |
| V²⁺ [symbol] V³⁺ + e⁻ | −0.26 |
| [VO]²⁺2H⁺ + e⁻ [symbol] [VO₂]⁺ + H₂O | +1.00 |

In contrast, the example systems of the present disclosure, which include symmetric redox flow batteries based on organic molecules, comprising an electroactive bipolar redox molecule combining an anolyte moiety and a catholyte moiety separated by a non-conjugating insulating linker, achieve much higher voltages than the aqueous alternative by suppressing solvent decomposition. For example, aqueous systems are limited by water electrolysis, which is initiated at potentials above 1.22 V. Symmetric operation is achieved by using the same electroactive bipolar redox molecule comprising anolyte and catholyte moieties separated by a non-conjugating insulating linker on each side of the membrane. In this symmetric system, the redox flow battery has identical components in each half-cell, which alleviates the problems associated with chemical gradients when different redox active organic molecules are on each side of the membrane resulting in membrane crossover, permanent contamination, and flow battery capacity decay.

The electroactive bipolar redox molecule comprises an anolyte moiety. Examples of suitable anolyte moieties include 1-methylnaphthalene, biphenyl, and stilbene.

The electroactive bipolar redox molecule comprises a catholyte moiety. Examples of suitable catholyte moieties include para-dimethoxybenzene.

The electroactive bipolar redox molecule comprises a non-conjugating insulating linker to connect the anolyte moiety and the catholyte moiety. Non-conjugating insulating linker may be defined by two double bonds separated by more than one single bond. Examples of suitable non-conjugating insulating linkers include two -CX₂ linkers, three -CX₂ linkers, four -CX₂ linkers, five-CX₂ linkers, ten -CX₂ linkers, a hundred -CX₂ linkers, a thousand -CX₂ linkers, and everything in between, wherein each X comprises at least one atom individually selected from the group consisting of hydrogen and a heteroatom.

In one or more embodiments, the electroactive bipolar redox molecule combines para-dimethoxybenzene with 1-methylnaphthalene, using at least two -CX₂ linkers between the redox active moieties. In other embodiments, the electroactive bipolar redox molecule combines para-dimethoxybenzene with biphenyl using at least two -CX₂ linkers between the redox active moieties. In one or more embodiments, the electroactive bipolar redox molecule combines para-dimethoxybenzene with stilbene using at least two -CX₂ linkers between the redox active moieties. In other embodiments, the electroactive bipolar redox molecule combines para-dimethoxybenzene with a combination of 1-methylnaphthalene, biphenyl, and stilbene using at least two -CX₂ linkers between the redox active moieties.

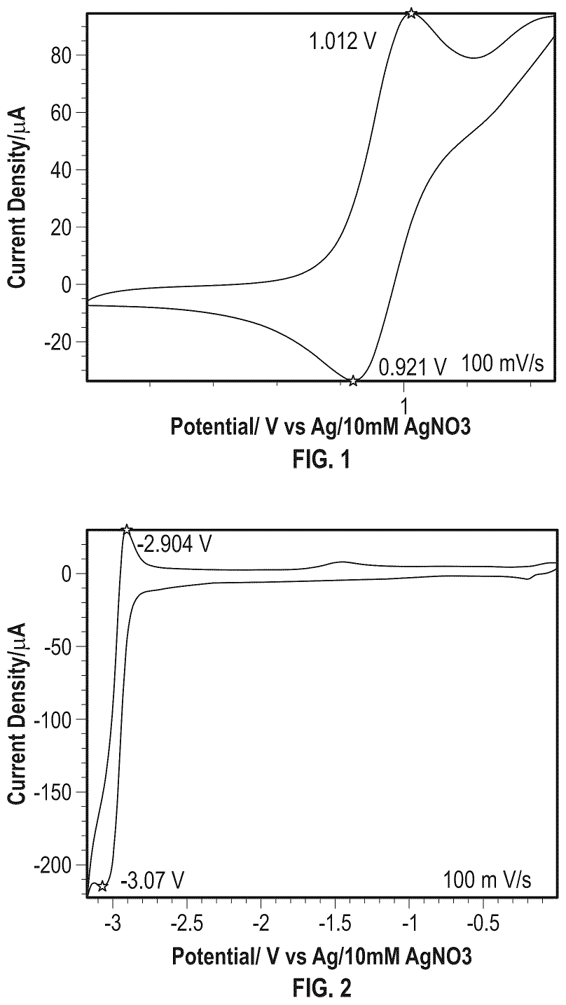

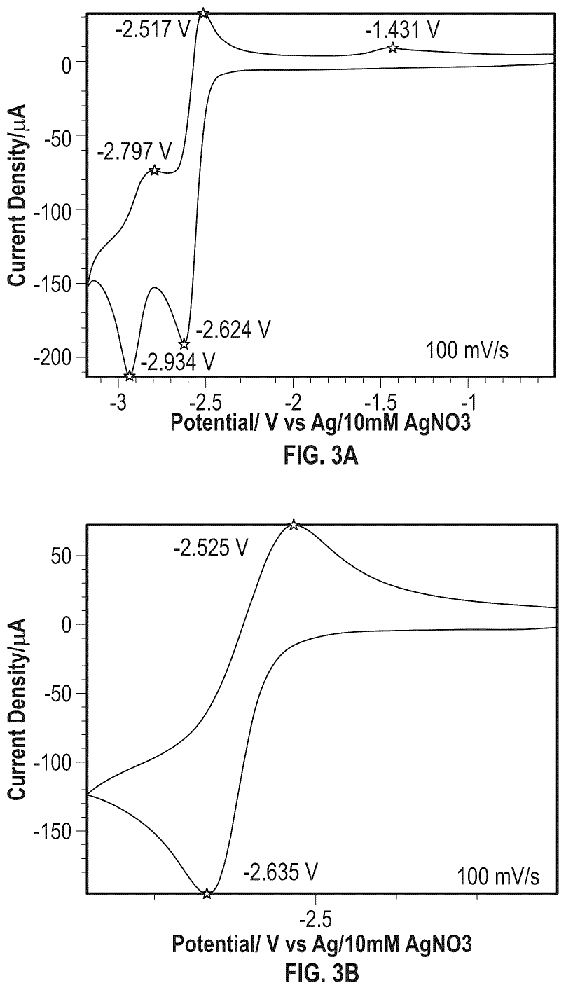

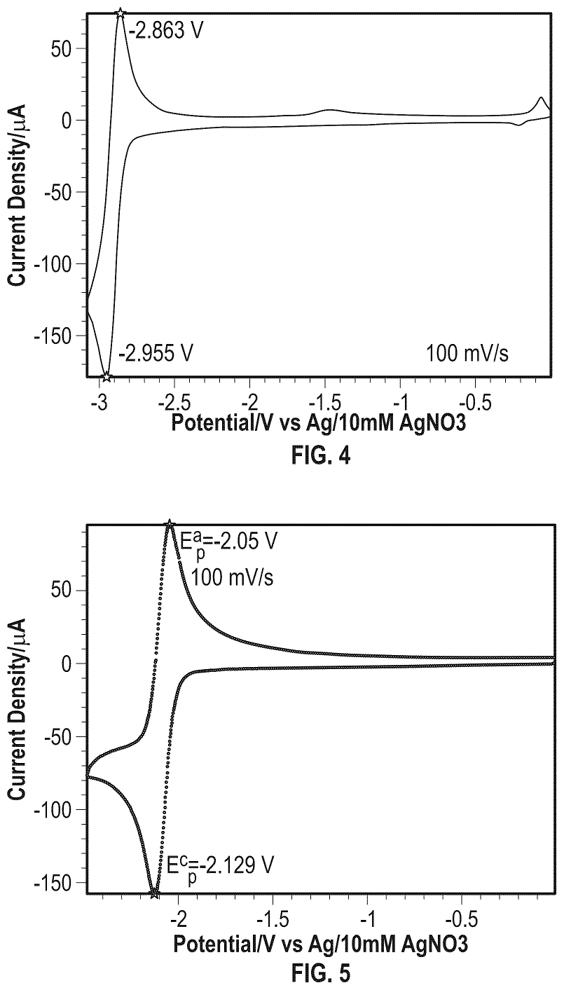

Cyclic voltammetry is a powerful and popular electro-chemical technique commonly employed to investigate the reduction and oxidation processes of molecular species. A cyclic voltammogram is acquired for each redox-active species, the oxidative peak and reductive peak recorded, and the halfway potential between the two observed peaks, E_{1/2}, calculated. All reported E_{1/2} values are measured against a silver/silver nitrate reference electrode (Ag|10 mM AgNO₃ in acetonitrile), whose potential is −0.09 V versus a ferrocene couple (Fc|Fc⁺). For instance, the attachment of a pair of electron-donating methoxy-substituents to benzene results in a molecule p-dimethoxybenzene with a highly reversible catholytic reaction with redox potential, E_{1/2}, at +0.967 V as illustrated in FIG. 1 with the cyclic voltammogram of 5 mM p-dimethoxybenzene+0.1 M N-tetrabutylammonium hexafluorophosphate (TBAPF₆) in acetonitrile (100 mV/s) between +0.5 V to +1.25 V. In contrast, biphenyl, one of the anolytes of the present disclosure, has a redox potential, E_{1/2}, at −2.987 V as illustrated in FIG. 2 by the cyclic voltammogram of 5 mM biphenyl+0.1 M N-tetrabutylammonium hexafluorophosphate (TBAPF₆) in acetonitrile (100 mV/s) between −3.2 V to +0 V. Trans-stilbene, another anolyte of the present disclosure, has a redox potential, E_{1/2}, at −2.571 V as illustrated in FIG. 3A by the cyclic voltammogram of 5 mM trans-stilbene+0.1M TBAPF₆ in acetonitrile at 100 mV/s between −3.2 V to +1.5 V and in FIG. 3B by the cyclic voltammogram of 5 mM trans-stilbene+0.1M TBAPF₆ in acetonitrile at 100 mV/s between −4 V to −1 V. 1-methylnaphthalene, another anolyte of the present disclosure, has a redox potential, E_{1/2}, at −2.909 V as illustrated in FIG. 4 by the cyclic voltammogram of 5 mM 1-methylnaphthalenc+0.1M TBAPF₆ in acetonitrile at 100 mV/s between −3.1 V to +0 V (1). Finally, FIG. 5 is a cyclic voltammogram of 5 mM benzophenone+0.1M TBAPF₆ in acetonitrile at 100 mV/s between −2.5 to +0 V.

### Redox Flow Batteries

Redox flow batteries are electrochemical devices that store energy in the different oxidation states of the selected elements. Often, these elements are soluble and exist as ions dissolved in an acidic solvent. The principle of operation for redox flow batteries is similar to that of conventional batteries, where oxidation and reduction reactions at two electrodes enables electrons to flow. The difference with a redox flow battery is the manner in which the reactants are stored. Redox flow batteries typically include two electrodes, a separator, and an electrolyte. However, the reactants are stored as dissolved ions in a solution, rather than physically incorporated into the electrode. As such, the reactant solutions for redox flow batteries can be stored in tanks, and then the solutions can be pumped through a cell where the reactions will occur to generate electricity.

In one or more embodiments, the redox flow battery of the present disclosure includes an electroactive bipolar redox molecule. The electroactive bipolar redox molecule combines anolyte and catholyte moieties separated by a non-conjugating insulating linker. Outstanding electrochemical cell potentials are achieved combining para-dimethoxybenzene as catholyte moiety with 1-methylnaphthalene as anolyte moiety, para-dimethoxybenzene as catholyte moiety with biphenyl as anolyte moiety, and combining para-dimethoxybenzene as catholyte moiety with stilbene as anolyte moiety using at least two -CX₂ linkers between the redox active moieties, wherein each X comprises at least one atom individually selected from the group consisting of hydrogen and a heteroatom. However, if these redox active moieties were linked with one -CX₂ linker, the resulting molecules are redox inactive. Therefore, the length of the -CX₂ linker between the redox active moieties has an impact on the redox activity and the electrochemical cell potential.

Disclosed herein is also a method for reversibly storing electrical energy in a redox flow battery with a unit cell potential greater than 3.5 volts. The method includes flowing the electroactive bipolar redox molecule into contact with a first metal electrode in a positive section of the redox flow battery as catholyte, wherein the electroactive bipolar redox molecule combines anolyte and catholyte moieties separated by a non-conjugating insulating linker. The method further includes flowing the single electroactive bipolar redox molecule into contact with a second metal electrode in a negative section of the redox flow battery as anolyte, wherein the negative section is separated from the positive section with an ion-transporting membrane, wherein the anolyte is dissolved in additional solvent; and supplying electrical energy to the first metal electrode and the second metal electrode while an external load is not in electrical communication with the first metal electrode and the second metal electrode to charge the redox flow battery while flowing the catholyte and flowing the anolyte. The solvent may be the same in the positive section and in the negative section of the redox flow battery or it may be different. The redox flow battery can further include a single tank or two separate tanks, one to supply the positive section, also called the catholyte tank, and the other tank, the anolyte tank, to supply the negative section, each tank holding the electroactive bipolar redox molecule. A catholyte pump can be used to circulate the electroactive bipolar redox molecule from the catholyte tank to the positive portion while an anolyte pump circulates the electroactive bipolar redox molecule from the anolyte tank to the negative portion. The redox flow battery can further include a load for directing electrical energy into or out of the redox flow battery.

The electrolyte solutions comprise the electroactive bipolar redox molecule organic molecule with at least one redox state dissolved in a solvent. For instance, the electrolyte comprising the redox organic molecule in one or more redox states may also comprise one or more solvents and one or more ionically dissociative compounds as supporting electrolyte. The solvent can be any solvent that is non-reactive with the electroactive bipolar redox molecule and permits the redox active organic molecule to efficiently undergo redox reactions such that the energy storage system can be effectively charged and discharged. The solvent may be the same in the positive section and in the negative section of the redox flow battery or it may be different.

The solvent of the present disclosure can be, for example, aqueous-based or non-aqueous (organic), protic or aprotic, and cither polar or non-polar. The aqueous-based solvent can be, for example, water, or water in admixture with a water-soluble co-solvent. Some examples of protic organic solvents include alcohols, such as methanol, ethanol, n-propanol, isopropanol, n-butanol, sec-butanol, isobutanol, t-butanol, n-pentanol, isopentanol, 3-pentanol, neopentyl alcohol, n-hexanol, 2-hexanol, 3-hexanol, 3-methyl-1-pentanol, 3,3-dimethyl-1-butanol, isohexanol, and cyclohexanol. The protic organic solvent may alternatively be or include a carboxylic acid, such as acetic acid, propionic acid, butyric acid, or a salt thereof.

Some examples of polar aprotic solvents include nitrile solvents (e.g., acetonitrile, propionitrile, and butyronitrile), sulfoxide solvents (e.g., dimethyl sulfoxide, ethyl methyl sulfoxide, diethyl sulfoxide, methyl propyl sulfoxide, and ethyl propyl sulfoxide), sulfone solvents (e.g., methyl sulfone, ethyl methyl sulfone, methyl phenyl sulfone, methyl isopropyl sulfone, propyl sulfone, butyl sulfone, tetramethylene sulfone, i.e., sulfolane), amide solvents (e.g., N,N-dimethylformamide, N,N-diethylformamide, acetamide, dimethylacetamide, and N-methylpyrrolidone), ether solvents (e.g., diethyl ether, 1,2-dimethoxyethane, 1,2-diethoxyethane, 1,3-dioxolane, and tetrahydrofuran), carbonate solvents (e.g., propylene carbonate, ethylene carbonate, butylene carbonate, chloroethylene carbonate, fluorocarbonate solvents, dimethyl carbonate, diethyl carbonate, dipropyl carbonate, ethyl methyl carbonate, methyl propyl carbonate, and ethyl propyl carbonate), organochloride solvents (e.g., methylene chloride, chloroform, 1,1,-trichloroethane), ketone solvents (e.g., acetone and 2-butanone), and ester solvents (e.g., 1,4-butyrolactone, ethylacetate, methylpropionate, ethylpropionate, and the formates, such as methyl formate and ethyl formate). The polar aprotic solvent may also be or include, for example, hexamethylphosphoramide (HMPA), 1,3-dimethyl-3,4,5,6-tetrahydro-2 (1H)-pyrimidinone (DMPU), or propylene glycol monomethyl ether acetate (PGMEA). Some examples of polar inorganic solvents include supercritical carbon dioxide, carbon disulfide, carbon tetrachloride, ammonia, and sulfuryl chloride fluoride. Some examples of non-polar solvents include the liquid hydrocarbons, such as the pentanes, hexanes, heptanes, octanes, pentenes, hexenes, heptenes, octenes, benzene, toluenes, and xylenes.

In some embodiments, the electrolyte of the present disclosure also comprises ionic salts as supporting electrolytes. A necessary attribute is that these salts dissociate ionically in the solvent and have a solubility of at least 0.1 moles per liter of solution, or 0.1 M and up to 10 M. Examples include salts containing alkali metals (Li, Na, K, Rb, Cs), quaternary ammonium, oxonium, sulfonium cations. Examples also include salts containing BF₄, trifluoromethanesulfonimide, PF₆, nitrate and halogen group anions. In yet other embodiments, the solvent and supporting electrolyte may be the same materials. Examples of these include ionic liquids containing imidazolium-, pyrrolidinium-, phosphonium-, trialkyloxonium, trialkylsulfonium cations, either alone or in admixture with a non-ionic liquid solvent.

The electroactive bipolar redox molecule of the present disclosure is present in the solvent in any suitable amount. For example, from 0.01 M to 5 M, or from 0.01 M to 1 M, or from 0.025 to 0.5 M of the electroactive bipolar redox molecule is present in the system.

The positive and negative electrodes may be any suitable electrode. For example, the positive and negative electrodes may be independently selected from, for example, graphite, carbon felt, glassy carbon, nickel on carbon, porous nickel sulfide, nickel foam, platinum, palladium, gold, titanium, titanium oxide, ruthenium oxide, iridium oxide, or a composite, such as a carbon-polyolefin composite, or a composite containing polyvinylidene difluoride (PVDF) and activated carbon, or a composite of platinum and titanium, e.g., platinized titanium. In some embodiments, the electrode material may include or be composed of an element selected from C, Si, Ga, In, Al, Ti, V, Cr, Fc, Co, Ni, Cu, Zr, Nb, Ta, Mo, W, Rc, Ru, Os, Rh, Ir, Pd, Pt, Ag, Au, alloys thereof, degenerately-doped semiconductors thereof, and oxides thereof. The choice of electrode material may be dependent on the choice of redox active molecule, solvent, and other aspects of the redox flow battery in particular embodiments. For this reason, any of the specific classes or types of electrode materials described above may be excluded or specifically selected in particular embodiments.

The separator separates the catholyte in the positive compartment or positive section from the anolyte in the negative compartment or negative section to prevent the organic redox molecules in the positive and negative sections from intermingling with each other. However, the separator should possess a feature that permits the passage of non-redox-active species between the catholyte and anolyte. The non-redox-active species are those ionic species, well known in the art, that establish electrical neutrality and complete the circuitry in a battery, and which are included as either a supporting electrolyte or are formed during the course of the redox reactions in each compartment. In order to permit flow of non-redox-active species, the separator may be, to some extent, porous. Some examples of inorganic or ceramic compositions for the separator component include alumina, silica (e.g., glass), titania, and zirconia. Porous organic polymers that do not separate by ionic charge but rather, size exclusion, may also be used. These can work like physical barriers directing flow geometry to prevent mixing. The separator component may operate selectively or non-selectively in its ion permeability. The separator component can have any suitable thickness and hardness. In some embodiments, the separator component is in the form of a membrane.

In a particular embodiment, the separator is an ion-selective membrane. The ion-selective membrane, also known as an ion exchange membrane (IEM), can be any organic, inorganic (e.g., ceramic), hybrid, or composite membranes known in the art, such as those used in redox flow batteries of the art and suitable for the purposes of the invention described herein. The ion-selective membrane should substantially or completely block passage of the redox active molecule between positive and negative compartments while permitting the flow of solvent molecules and/or ion species that may evolve or be present during the electron transport process, such as hydrogen ions, halide ions, or metal ions. In some embodiments, the ion-selective membrane is a cation-selective membrane, while in other embodiments, the ion-selective membrane is an anion-selective membrane. The ion-selective membrane can include or be composed of, for example, poly(ether ether ketone) (PEEK) or sulfonated version thereof (SPEEK), poly(phthalazinone ether sulfone) (PPES) or sulfonated version thereof (SPPES), poly(phthalazinone ether sulfone ketone) (PPESK) or sulfonated version thereof (SPPESK), or an ionomer, which may be a proton conductor or proton exchange membrane, particularly a fluoropolymer (e.g., a fluoroethylene or fluoropropylene), such as a sulfonated tetrafluoroethylene-based fluoropolymer, such as Nafion®. In some embodiments, the ion-selective membrane has a hybrid structure having an organic component, such as any of the exemplary organic compositions above, in combination with an inorganic material, such as silicon (SiO₂). The hybrid structure can be produced by, for example, a sol gel process. The ion-selective membrane may alternatively be a composite, which includes separate layers of different membrane materials in contact with each other. The choice of membrane material may be dependent on the choice of redox active molecule, solvent, and other aspects of the redox flow battery in particular embodiments. For this reason, any of the specific classes or types of separator materials described above may be excluded or specifically selected in particular embodiments.

In some embodiments, the positive and negative sections may include a plurality of cells in electrical series defined by a stacked repetitive arrangement of a conductive intercell separator having generally a bipolar function, a first metal electrode, an ion exchange membrane, a second metal electrode and another conductive intercell separator. In one or more embodiments, the electrochemical stack comprises a plurality of electrochemical cells, each comprising a current collector for passage of electrical current and flow fields. In one or more embodiments, the stacked repetitive arrangement forming a battery stack comprises from 2 to 200 electrochemical cells.

Supplementary components may include an optional heat exchanger to dissipate heat due to resistive heating, an optional purge gas such as nitrogen or noble gases (xenon, argon, helium, neon, krypton) to exclude air and water vapor, a recirculation device such as a pump, tubing and manifolds used to direct the transport of the fluid electrolyte between one or more storage tank.

As a redox flow battery operates by flowing the electrolyte solutions over the respective electrodes, the redox flow battery includes circulation devices or pumps or other suitable devices for establishing flow of the electrolyte solutions. In addition to pumps, suitable devices may include a propeller designed for use within a liquid to establish fluid flow. Typically, the redox flow battery includes at least two flow devices, one designated for establishing flow in the positive section, and the other designated for establishing flow in the negative section.

In one embodiment, the electrolyte solutions contained in the positive and negative sections constitute the entire amount of electrolyte solution in the redox flow battery, i.e., no further reserve of electrolyte solution is hydraulically connected with the positive and negative sections. In another embodiment, the positive and negative sections are each connected by one or more conduits (e.g., a pipe or a channel) to storage (reservoir) tanks containing additional electrolyte solution. The additional electrolyte can be stored in one tank connected to the positive and negative section as the electroactive bipolar redox molecule of the disclosure can act as catholyte and as anolyte. Alternatively, at least two tanks can be used to replenish the positive and negative sections. The storage tanks can advantageously serve to replenish spent electrolyte solution and increase the electrical capacity of the redox flow battery. The storage tanks can also advantageously serve to promote flow of the electrolyte solutions, particularly in an arrangement where the positive and negative sections are each connected to at least two storage tanks, in which case the redox flow battery would have at least four storage tanks.

In another aspect, the invention is directed to a method for storing and releasing electrical energy by use of the above-described redox flow battery. In the method, the redox flow battery is first charged by supplying electrical energy to the first metal electrode and the second metal electrode while the external load is not in electrical communication with the first metal electrode and the second metal electrode and while flowing the catholyte and anolyte, during which the organic molecule in the positive section is oxidized and the organic in the negative section is reduced. As such, the electrical energy has been converted and stored as electrochemical energy. The electrochemical energy is stored in the energetically uphill half reactions occurring in the positive and negative sections during the charging process. The resulting electrochemical potential energy is stored until a discharging process occurs, during which the stored electrochemical energy is converted to electrical energy while flowing the catholyte and anolyte, with concomitant reversal of the two half reactions (i.e., reduction in the positive section and oxidation in the negative section) to form the initial lower energy redox molecules present in both compartments before the charging process. Each half reaction generally operates by one or more one-electron processes, but they may also operate by multi-electron processes (e.g., one or more, two-, three-, or four-electron processes), depending on the redox active molecule. The source of electrical energy in the charging process can be any desired source of electrical energy. In particular embodiments, the source of electrical energy is a renewable source of energy, such as wind, solar, or hydropower, for example.

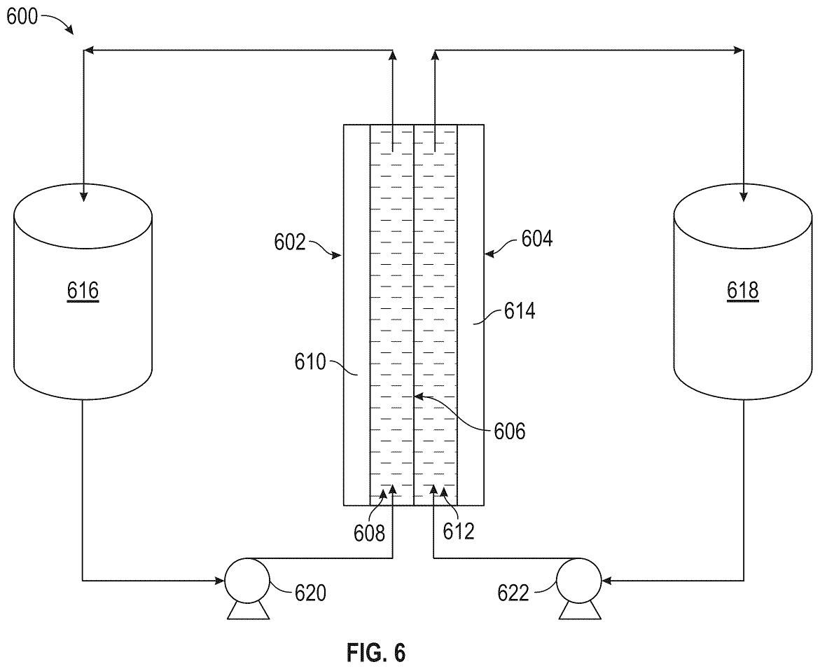

FIG. 6 is an example schematic of a redox flow battery system 600 for energy storage. In the illustrated embodiment, the redox flow battery system 600 includes a positive section 602 and a negative section 604. A separator 606 (e.g., a porous separator or an ion selective membrane) separates the positive section 602 from the negative section 604. As illustrated, the positive section 602 includes a catholyte 608 (positive electrolyte solution) in contact with a first metal electrode 610, (the cathode or positive electrode). As further illustrated, the negative section 604 includes an anolyte 612 (negative electrolyte solution) in contact with a second metal electrode 614 (the anode or negative electrode). In this example, the energy is stored as dissolved ions within the solution, and the amount of energy for the system depends only on the amount of solution available in the catholyte tank 616 and the anolyte tank 618. Larger tanks will be able to store larger amounts of solution, leading to a longer duration discharge. Meanwhile, the power rating of the redox flow battery system 600 is dictated by the cell-level design, such as flow path, the first metal electrode 610, and the second metal electrode 614. The flow rate is controlled by catholyte pump 620 for the catholyte 608 and anolyte pump 622 for the anolyte 612. While “positive” and “negative” are used to describe sections of the redox flow battery 6 system 00, these references do not require that the redox flow battery system 600 be in operation and possess positive or negative polarity, but rather indicates suitability for operation to oxidize/reduce.

Accordingly, the present disclosure may provide redox electrochemical systems comprising high-voltage multivalent organic molecules comprising the single electroactive bipolar redox molecule of the present disclosure and methods of identifying these systems. The methods and systems may include any of the various features disclosed herein, including one or more of the following embodiments.

Embodiment 1. A system for energy storage comprising: an electroactive bipolar redox molecule comprising an anolyte moiety and a catholyte moiety separated by a non-conjugating insulating linker, wherein the catholyte moiety comprises para-dimethoxybenzene and the non-conjugating insulating linker comprises at least two -CX₂ linkers, wherein each X comprises at least one atom individually selected from the group consisting of hydrogen and a heteroatom; a positive section comprising a first metal electrode in contact with the electroactive bipolar redox molecule and a supporting electrolyte dissolved in a solvent; and a negative section comprising a second metal electrode in contact with the electroactive bipolar redox molecule and additional electrolyte dissolved in additional solvent.

Embodiment 2. The system of Embodiment 1, wherein the single electroactive bipolar redox molecule has at least 2 electrochemically reversible redox states separated by at least 3.0 V.

Embodiment 3. The system of Embodiment 1 or Embodiment 2, wherein the anolyte moiety comprises 1-methylnaphthalene.

Embodiment 4. The system of any preceding Embodiments, wherein the anolyte moiety comprises biphenyl.

Embodiment 5. The system of any preceding Embodiments, wherein the anolyte moiety comprises stilbene.

Embodiment 6. The system of any preceding Embodiments, wherein the anolyte moiety comprises benzophenone.

Embodiment 7. The system of any preceding Embodiments, wherein the non-conjugating insulating linker is two -CX₂ linkers.

Embodiment 8. The system of any preceding Embodiments, wherein the non-conjugating insulating linker is at least three -CX₂ linkers.

Embodiment 9. The system of any preceding Embodiments, wherein the system further comprises a tank for storing the electroactive bipolar redox molecule connected to the positive section and the negative section.

Embodiment 10. The system of any preceding Embodiments, further comprising from 2 to 200 electrochemical cells to form a battery stack, wherein each of the electrochemical cells comprises a corresponding positive section comprising the catholyte and a corresponding negative section comprising the anolyte.

Embodiment 11. The system of any preceding Embodiments, wherein the solvent and additional solvent are each an aprotic solvent selected from the group consisting of acetonitrile, dimethyl sulfoxide, sulfolane, dimethylacetamide, dimethylformamide, propylene carbonate, ethylene carbonate propyl sulfone, and butyl sulfone.

Embodiment 12. The system of any preceding Embodiments, wherein the positive section is separated from the negative section by a porous separator and/or an ion-selective membrane, and wherein the system further comprises a circulation device configured to circulate the catholyte or the anolyte from a storage tank to the positive section or the negative section.

Embodiment 13. A composition comprising: a single electroactive bipolar redox molecule comprising an anolyte moiety and a catholyte moiety separated by a non-conjugating insulating linker, wherein the catholyte moiety comprises para-dimethoxybenzene and the non-conjugating insulating linker comprises at least two -CX₂ linkers, wherein each X comprises at least one atom individually selected from the group consisting of hydrogen and a heteroatom.

Embodiment 14. The composition of Embodiment 13, wherein the single electroactive bipolar redox molecule has at least 2 electrochemically reversible redox states separated by at least 3.5 V.

Embodiment 15. The composition of Embodiment 13 or Embodiment 14, wherein the anolyte moiety comprises 1-methylnaphthalene.

Embodiment 16. The composition of any of Embodiments 13-15, wherein the anolyte moiety comprises biphenyl.

Embodiment 17. The composition of any of Embodiments 13-16, wherein the anolyte moiety comprises stilbene.

Embodiment 18. A method for reversibly storing electrical energy in a redox flow battery with a unit cell potential equal to or greater than 3.5 volts, the method comprising: flowing a catholyte into contact with a first metal electrode in a positive section of the redox flow battery, wherein the catholyte comprises a single electroactive bipolar redox molecule comprising an anolyte moiety and a catholyte moiety separated by a non-conjugating insulating linker, wherein the catholyte moiety comprises para-dimethoxybenzene and the non-conjugating insulating linker comprises at least two -CX₂ linkers, wherein each X comprises at least one atom individually selected from the group consisting of hydrogen and a heteroatom; flowing an anolyte into contact with a second metal electrode in a negative section of the redox flow battery, wherein the negative section is separated from the positive section with an ion-transporting membrane, wherein the anolyte comprises an additional portion of the organic molecule dissolved in additional solvent; and supplying electrical energy to the first metal electrode and the second metal electrode while an external load is not in electrical communication with the first metal electrode and the second metal electrode to charge the redox flow battery while flowing the catholyte and flowing the anolyte.

Embodiment 19. The method of Embodiment 18, further comprising discharging the redox flow battery by establishing electrical communication between the external load with the first metal electrode and the second metal electrode while flowing the catholyte and flowing the anolyte.

Embodiment 20. The method of Embodiment 18 or Embodiment 19, wherein the anolyte moiety comprises at least one anolyte moiety selected from the group consisting of 1-methylnaphthalene, biphenyl, stilbene, and any combination thereof.

To facilitate a better understanding of the present invention, the following examples of certain aspects of some embodiments are given. In no way should the following examples be read to limit, or define, the entire scope of the disclosure.

### Examples

Electrochemical screening methods were used to screen the specific compounds. One type of screening method was cyclic voltammetry screening experiments performed in a nitrogen-purged 3-electrode beaker cell using 5 mM of the screened redox species, acetonitrile solvent, and 0.1 M of N-tetrabutylammonium hexafluorophosphate (TBAPF₆) as supporting electrolyte. A silver wire in 10 mM silver nitrate (AgNO₃)+0.1 M TBAPF₆ in acetonitrile with a double junction was used as the reference electrode. The reference electrode potential was measured to be −0.09 V versus a Ferrocene|Ferrocenium (Fc|Fc+) redox couple. Voltammetry data was recorded at 100 mV/s using a Princeton Applied Research Versastat MC potentiostat. Electrochemical data was corrected for solution resistance by a manual ohmic compensation of 80-130Ω as measured using electrochemical impedance spectroscopy (EIS).

Table 2 is a summary of the measured half-cell potential determined by the arithmetic average of the anode and cathode peaks in the cyclic voltammograms (FIGS. 1-5) of the compounds identified with the highest half-cell voltages:

TABLE 2
Compounds Identified with the Highest Half-cell Voltages and Room Temperature
Solubility (moles per liter of solution) measured using acetonitrile solvent.

| | E_{1/2}⁰ | MeCN | | E_{1/2}⁰ | MeCN |
|---|---|---|---|---|---|
| Catholyte Redox | (V vs | solubility | | (V vs | solubility |
| Molecule | Ag\|Ag⁺) | (M) | Anolyte Redox Molecule | Ag\|Ag⁺) | (M) |
| 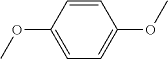 | +0.967 | 0.6 | 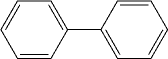 [SMILES: c1ccc(-c2ccccc2)cc1] | −2.987 | 1.73 |
| | | | 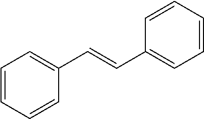 [SMILES: C(=C\c1ccccc1)/c1ccccc1] | −2.571 | 1.07 |
| | | | 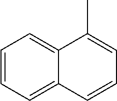 | −2.909 | miscible |
| | | | 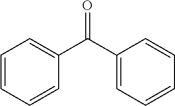 [SMILES: O=C(c1ccccc1)c1ccccc1] | −2.909 | 4.98 |

FIG. 1 is a cyclic voltammogram of 5 mM p-dimethoxybenzene+0.1 M N-tetrabutylammonium hexafluorophosphate (TBAPF₆) in acetonitrile (100 mV/s) between +0.5 V to +1.25 V. FIG. 2 is a cyclic voltammogram of 5 mM biphenyl+0.1 M N-tetrabutylammonium hexafluorophosphate (TBAPF₆) in acetonitrile (100 mV/s) between −3.2 V to +0 V. FIG. 3A is a cyclic voltammogram of 5 mM trans-stilbene+0.1M TBAPF₆ in acetonitrile at 100 mV/s between −3.2 to +1.5 V. FIG. 3B is a cyclic voltammogram of 5 mM trans-stilbene+0.1M TBAPF₆ in acetonitrile at 100 mV/s between −4 V to −1 V. FIG. 4 is a cyclic voltammogram of 5 mM 1-methylnaphthalene+0.1M TBAPF₆ in acetonitrile at 100 mV/s between −3.1 V to +0 V (1). FIG. 5 is a cyclic voltammogram of 5 mM benzophenone+0.1M TBAPF₆ in acetonitrile at 100 mV/s between −2.5 to +0 V.

Table 3 is a summary of the structures of bipolar compounds and cell voltages obtained combining the catholyte and anolyte of Table 2 using one or two -CH₂ insulating linker:

TABLE 3
Structures of Bipolar Compounds and Cell Voltages

| | | E_{cell}⁰ | E^{1/2} |
|---|---|---|---|
| Entry | Bipolar Compound | (V) | (V) |
| 1 | 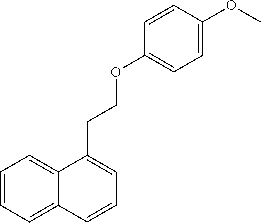 [SMILES: COc1ccc(OCCc2cccc3ccccc23)cc1] | 3.82 | +0.958 −2.857 |
| 2 | 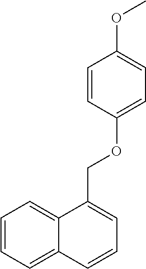 [SMILES: COc1ccc(OCc2cccc3ccccc23)cc1] | n/a | +0.981 |
| 3 | 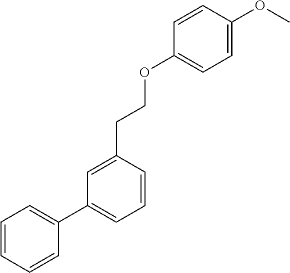 [SMILES: COc1ccc(OCCc2cccc(-c3ccccc3)c2)cc1] | 3.93 | +0.953 −2.976 |
| 4 | 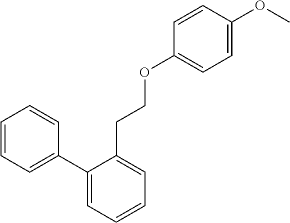 [SMILES: COc1ccc(OCCc2ccccc2-c2ccccc2)cc1] | 3.82 | +0.934 −1.217 |
| 5 | 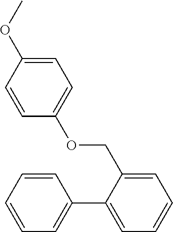 [SMILES: COc1ccc(OCc2ccccc2-c2ccccc2)cc1] | n/a | +0.985 |
| 6 | 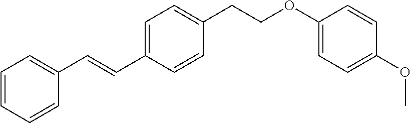 [SMILES: COc1ccc(OCCc2ccc(/C=C/c3ccccc3)cc2)cc1] | 3.73 | +1.096 −2.632 |
| 7 | 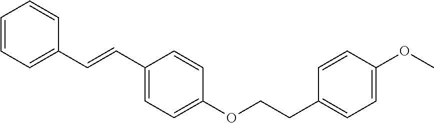 [SMILES: COc1ccc(CCOc2ccc(/C=C/c3ccccc3)cc2)cc1] | n/a | −2.665 |

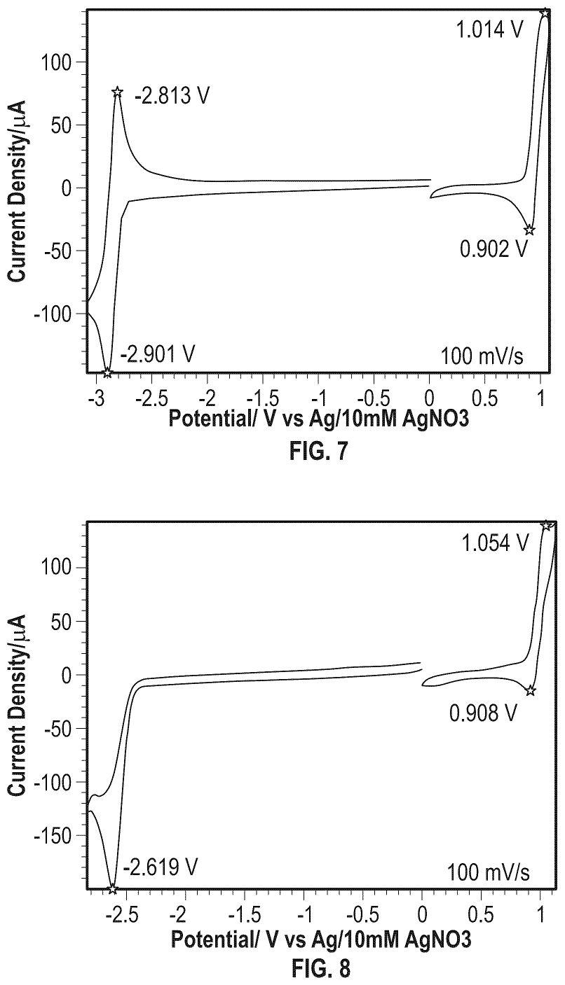

Entry 1 in row 1 of Table 3 represents the results of the combination of para-dimethoxybenzene linked with two -CH₂ insulating linker to 1-methylnaphthalene. FIG. 7 is the cyclic voltammogram of 5 mM bipolar of the resulting compound (1)+0.1M TBAPF₆ in acetonitrile at 100 mV/s between −3.1 V to +1.1 V. It should be noted that the cell potential of 3.82 V is outstanding. In contrast, entry 2 in row 2 represents the same catholyte and anolyte moieties but linked with a single -CH₂ group, which results in a non-redox active molecule. FIG. 8 is the cyclic voltammogram of 5 mM bipolar of the resulting compound (2)+0.1M TBAPF₆ in acetonitrile at 100 mV/s between −2.85 V to +1.15 V. This result shows the criticality of the insulating linker.

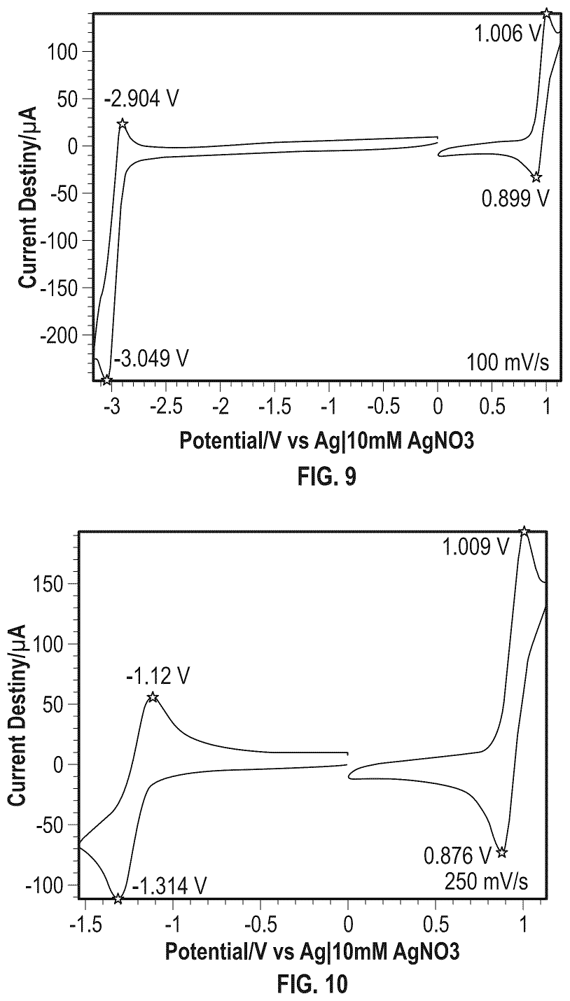

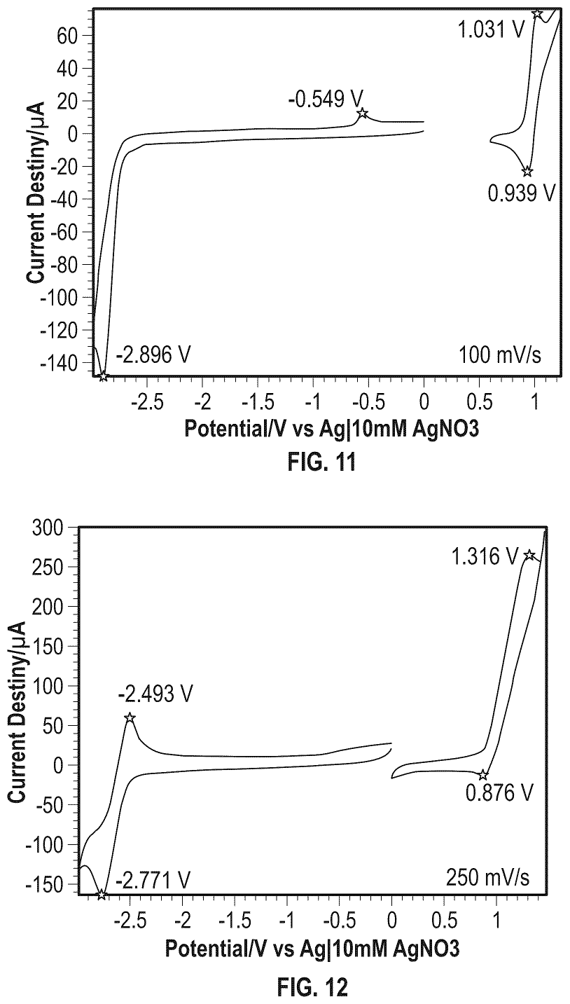

Entries 3 and 4 in rows 3 and 4 of Table 3, respectively, represent the results of the combination of para-dimethoxybenzene linked with two -CH₂ insulating linker to biphenyl in adjacent positions. FIG. 9 is the cyclic voltammogram of 5 mM the resulting bipolar compound (3)+0.1M TBAPF₆ in acetonitrile at 100 mV/s between −3.2 V to +1.15 V. FIG. 10 is the cyclic voltammogram of 5 mM bipolar compound (4)+0.1M TBAPF₆ in acetonitrile at 250 mV/s between −1.55 V to +1.15 V. The resulting cell potentials of 3.93 V and 3.82 V are both close to 4 V, which is outstanding. In contrast, entry 5 in row 5 of Table 2 representing the same catholyte and anolyte moieties but linked with a single -CH₂ group gives a non-redox active molecule. FIG. 11 is the cyclic voltammogram of 5 mM of the resulting bipolar compound (5)+0.1M TBAPF₆ in acetonitrile at 100 mV/s between-3.0 V to +1.25 V.

Entry 6 in row 6 of Table 3 represents the results of the combination of para-dimethoxybenzene linked with two -CH₂ insulating linker to stilbene. FIG. 12 is the cyclic voltammogram of 5 mM of the resulting bipolar compound (6)+0.1M TBAPF₆ in acetonitrile at 250 mV/s between −3.0 V to +1.5 V. It should be noted that the cell potential of 3.73 V is outstanding.

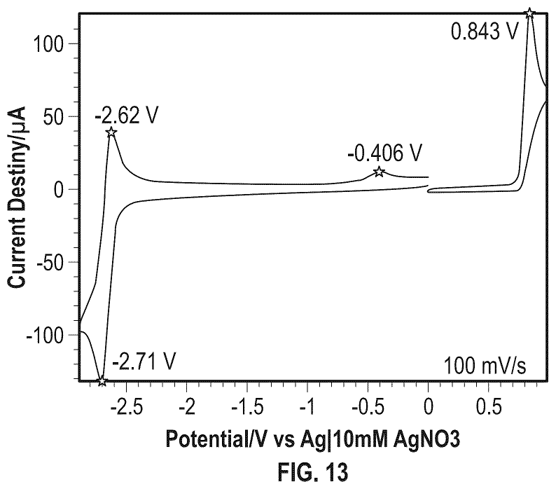

The position of the oxygen was also tested in entry 7 in row 7 of Table 3 as an oxygen linked to the stilbene to a para-methoxy-ethylbenzene gives a non-redox active molecule. FIG. 13 is the cyclic voltammogram of 5 mM of the resulting bipolar compound (7)+0.1M TBAPF₆ in acetonitrile at 100 mV/s between −3.0 V to +0 V.

In some embodiments, the hydrogens on the CX₂ linker may be replaced by halogens, such as fluorine, chlorine, bromine, or iodine for example, to be of the form CX₂. At least two single carbon-carbon bonds are necessary to ensure that the insulating linker is able to ensure the electrochemically reversibility of both moieties present on the molecule.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

What is claimed is:

1. A system for energy storage comprising:
an electroactive bipolar redox molecule comprising an anolyte moiety and a catholyte moiety separated by a non-conjugating insulating linker, wherein the catholyte moiety comprises para-dimethoxybenzene and the non-conjugating insulating linker comprises at least two -CX₂ linkers, wherein each X comprises at least one atom individually selected from the group consisting of hydrogen and a heteroatom;
a positive section comprising a first metal electrode in contact with the electroactive bipolar redox molecule and a supporting electrolyte dissolved in a solvent; and
a negative section comprising a second metal electrode in contact with the electroactive bipolar redox molecule and additional electrolyte dissolved in additional solvent.

2. The system of claim 1, wherein the electroactive bipolar redox molecule has at least 2 electrochemically reversible redox states separated by at least 3.0 V.

3. The system of claim 1, wherein the anolyte moiety comprises 1-methylnaphthalene.

4. The system of claim 1, wherein the anolyte moiety comprises biphenyl.

5. The system of claim 1, wherein the anolyte moiety comprises stilbene.

6. The system of claim 1, wherein the anolyte moiety comprises benzophenone.

7. The system of claim 1, wherein the non-conjugating insulating linker is two -CX₂ linkers.

8. The system of claim 1, wherein the non-conjugating insulating linker is at least three -CX₂ linkers.

9. The system of claim 1, wherein the system further comprises a tank for storing the electroactive bipolar redox molecule connected to the positive section and the negative section.

10. The system of claim 1, further comprising from 2 to 200 electrochemical cells to form a battery stack, wherein each of the electrochemical cells comprises a corresponding positive section comprising a catholyte and a corresponding negative section comprising an anolyte.

11. The system of claim 1, wherein the solvent and additional solvent are each an aprotic solvent selected from the group consisting of acetonitrile, dimethyl sulfoxide, sulfolane, dimethylacetamide, dimethylformamide, propylene carbonate, ethylene carbonate propyl sulfone, and butyl sulfone.

12. The system of claim 1, wherein the positive section is separated from the negative section by a porous separator and/or an ion-selective membrane, and wherein the system further comprises a circulation device configured to circulate a catholyte or an anolyte from a storage tank to the positive section or the negative section.

13. A composition comprising:
a single electroactive bipolar redox molecule comprising an anolyte moiety and a catholyte moiety separated by a non-conjugating insulating linker, wherein the catholyte moiety comprises para-dimethoxybenzene and the non-conjugating insulating linker comprises at least two-CX₂ linkers, wherein each X comprises at least one atom individually selected from the group consisting of hydrogen and a heteroatom;
a supporting electrolyte dissolved in a solvent; and
additional electrolyte dissolved in additional solvent.

14. The composition of claim 13, wherein the single electroactive bipolar redox molecule has at least 2 electrochemically reversible redox states separated by at least 3.0 V.

15. The composition of claim 13, wherein the anolyte moiety comprises 1-methylnaphthalene.

16. The composition of claim 13, wherein the anolyte moiety comprises biphenyl.

17. The composition of claim 13, wherein the anolyte moiety comprises stilbene.

18. A method for reversibly storing electrical energy in a redox flow battery with a unit cell potential equal to or greater than 3.5 volts, the method comprising:
flowing a catholyte into contact with a first metal electrode in a positive section of the redox flow battery, wherein the catholyte comprises a single electroactive bipolar redox molecule comprising an anolyte moiety and a catholyte moiety separated by a non-conjugating insulating linker, wherein the catholyte moiety comprises para-dimethoxybenzene and the non-conjugating insulating linker comprises at least two -CX₂ linkers, wherein each X comprises at least one atom individually selected from the group consisting of hydrogen and a heteroatom;
flowing an anolyte into contact with a second metal electrode in a negative section of the redox flow battery, wherein the negative section is separated from the positive section with an ion-transporting membrane, wherein the anolyte comprises an additional portion of an organic molecule dissolved in additional solvent; and
supplying electrical energy to the first metal electrode and the second metal electrode while an external load is not in electrical communication with the first metal electrode and the second metal electrode to charge the redox flow battery while flowing the catholyte and flowing the anolyte.

19. The method of claim 18, further comprising discharging the redox flow battery by establishing electrical communication between the external load with the first metal electrode and the second metal electrode while flowing the catholyte and flowing the anolyte.

20. The method of claim 18, wherein the anolyte moiety comprises at least one anolyte moiety selected from the group consisting of 1-methylnaphthalene, biphenyl, stilbene, and any combination thereof.
